(19) United States
(12) Patent Application Publication
(10) Pub. No.: US 2017/0345270 A1
(43) Pub. Date: Nov. 30, 2017

(54) ENVIRONMENT-TRIGGERED USER ALERTING

(71) Applicants: Jagadish Vasudeva Singh, Bangalore (IN); Vikas Mishra, Bangalore (IN); Sumod Cherukkate, Bangalore (IN)

(72) Inventors: Jagadish Vasudeva Singh, Bangalore (IN); Vikas Mishra, Bangalore (IN); Sumod Cherukkate, Bangalore (IN)

(21) Appl. No.: 15/167,506

(22) Filed: May 27, 2016

(51) Int. Cl. G08B 21/02

(52) U.S. Cl. CPC G08B 21/02

(57) ABSTRACT

Embodiments are directed to notifying a user of a computing device in response to detectable events. A context assessment generates context indicia relating to usage of the computing device based on sensor data and content data of the computing device. An event descriptor assessment produces a master set of event descriptors based on the context indicia and on event descriptor selection criteria, with the event descriptors representing events monitorable by the computing device. An event descriptor relevance assessment is made to produce a smaller active subset of event descriptors containing events to be monitored by the computing device such that in response to detection of any of the events to be monitored a user notification is triggered.

### TECHNICAL FIELD

Embodiments described herein generally relate to information processing and mobile computing and, more particularly, to the use of a computing device for monitoring a user's immediate environment for the occurrence of events that may be relevant to the user, and alerting the users in response to such events.

### BACKGROUND

Computing devices, particularly mobile computing devices, are able to provide immersive user experiences during such applications as media playback, gaming, real-time communications and conferencing, among countless other uses. An immersive user experience is one where a user's attention is drawn away from the user's environment. As a simple example, consider the use case of a user using their mobile device to listen to music via headphones while walking down the sidewalk, or through an airport. The music playback may prevent the user from hearing a public-address announcement or a spoken warning. In an even more immersive user-experience scenario, a user may be wearing a virtual-reality headset that effectively isolates the user's visual and auditory senses from the user's immediate environment, and almost entirely distracts the user's attention from his or her surroundings. A practical solution is needed to alert the user in response to the occurrence of significant events.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating some of the components of an example computing device according to an embodiment of the invention.

FIG. 2 is a block diagram illustrating an exemplary system architecture of a computing device such as the device of FIG. 1, according to an embodiment.

FIG. 3 is a diagram illustrating an exemplary hardware and software architecture of a computing device such as the one depicted in FIG. 2, in which various interfaces between hardware components and software components are shown.

FIG. 4 is a system block diagram illustrating an environment-triggered user alert system according to an example embodiment.

FIGS. 5A and 5B respectively illustrate a sensor interface, and a content interface of the system depicted in FIG. 4, according to various embodiments.

FIG. 6 is a block diagram illustrating various components of a context assessor of the system depicted in FIG. 4 according to an example embodiment.

FIG. 7 is a block diagram illustrating an event descriptor assessor of the system depicted in FIG. 4 according to an example embodiment.

FIG. S is a block diagram illustrating event descriptor relevance assessor of the system depicted in FIG. 4 according to an example embodiment.

FIG. 9 is a diagram illustrating an illustrative example of a data structure of an event descriptor.

FIG. 10 illustrates operations for managing a master event descriptor list according to an example embodiment.

FIG. 11 illustrates operations for managing an active event descriptor list according to an example embodiment.

### DETAILED DESCRIPTION

Aspects of the embodiments are directed to computing devices that support an intelligent alert mechanism based on events occurring in the surrounding environment, such as audible cues, for example. Audible cues include spoken words and other sounds, such as chimes (e.g., doorbell, alarm clock, etc.), sirens, vehicle sounds (e.g., running engine, approaching railcar, etc.). Events include other occurrences or phenomena, such as visual cues (e.g., sudden loss of ambient lighting, strobe alert, etc.).

According to various embodiments, a wide variety of computing devices are contemplated, such as mobile computing devices (e.g., smartphones, tablets, laptops, virtual/augmented reality head-mounted devices, smart glasses, smart watches, ear- or head-mounted audio players, and the like). A computing device may have a variety of integrated data capture devices, or may be interfaced with a distinctly-housed data capture device.

Computing devices according to various embodiments may be configured to monitor their respective environments for specific sounds or spoken keywords, as well as one or more visual cues. For ease of discussion, some examples below are described in the context of audible cues, such as spoken keywords, for instance. It will be appreciated by persons having skill in the relevant arts that similar principles may be applicable for other types of audible cues and, more generally, for other types of events.

There are practical limitations to the number of events, such as audible cues, for instance, that may be monitored at a given time. In general, each audible cue that is subject to monitoring has a processing cost associated with it. The processing cost has an energy requirement, thereby impacting battery consumption for mobile devices. In addition, the processing cost takes computing resources, thereby affecting the system's responsiveness and overall user experience.

In one type of embodiment, the number of events to be monitored by a computing device is limited so as to provide a good user experience in terms of timely processing without adversely affecting the device's battery life. To this end, in some embodiments, a contextually-relevant set of monitored events, which may be considered to be a subset of all events that the computing device may monitor, is selected for monitoring.

Some illustrative examples of use cases where solutions described herein may be applicable include:
The user is at home immersed in a virtual environment when a child or other person calls out to the user (e.g., crying baby);
The user at the workplace utilizing a virtual environment when a colleague calls out for the sake of safety;
The user is at an airport and wearing noise-canceling headphones or listening to music while wishing to not miss any announcements concerning the user's name, flight number, or gate number;
The user is at a shopping center and wishes to be alerted regarding any sales or discount announcements;
The user is in the company of non-English speaking people and wishes to be alerted to keywords in the language being spoken;
The user reads about an article about a planned travel destination, and wishes to monitor for the utterance of keywords based on the article;
The user is walking along a street and wishes to be alerted to specific keywords being spoken.

Aspects of the embodiments include a solution to automatically update the set of monitored event descriptors, such as visuals, sounds, or keywords, which are used by the computing device to check for matches against occurrences of events captured from the computing device's environment, based on the current usage context. This contextual awareness may be achieved by the analysis of one or more context sources. According to various embodiments, the context sources include such items as the location of the computing device, calendar information stored in the computing device, the content of email or other messaging received or sent by the computing device, detected broadcasted advertisements, detected language, and the like.

In various embodiments, a relevance engine may be implemented locally at the computing device, remotely at a different computing device (e.g., a server or cloud service), or as a combination of local and remote processing. The relevance engine(s) are each programmed, or otherwise configured, to determine the contextually-relevant active set of monitored event descriptors against which the captured environmental occurrences from the computing device's surroundings are to be matched.

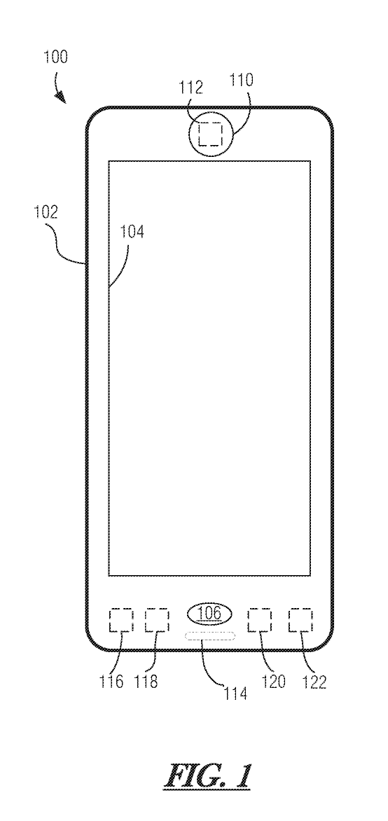

FIG. 1 is a block diagram illustrating some of the components of an example computing device 100 according to an embodiment. Computing device 100 is illustrated as a smartphone in this example, through it will be understood that computing device 100 is representative of other types of computing devices, which may have more or fewer data capture devices or other features than exemplary computing device 100. Computing device 100 has a housing 102 that encloses the interior components. Housing 102 may provide access to the interior of device 100 to some degree. For instance, in devices with a user-replaceable battery, flash memory card, or subscriber identity engine (SIM) card, housing 102 may include a user-removable cover. In devices having a design that does not facilitate user access to the interior, housing 102 may nonetheless have a provision for permitting access to technicians so that certain components may be repaired or replaced if needed.

Computing device 100 further includes one or more display screens 104 which may form a part of the overall enclosure of device 100 in cooperation with housing 102. Display 104 includes hardware that functions as an output device (e.g., an organic light-emitting diode (MED) screen for visual display, power and controller circuitry, etc.). In a related embodiment, display 104 include a touchscreen input device generally layered over (or under) the visual display and formed from a suitable touch or proximity-sensitive technology (e.g., capacitive, resistive, optical, ultrasonic, etc.), along with the corresponding detection and power circuitry.

Additionally, computing device 100 includes user input device 106, which in this example represents one or more user-operable input devices, such as button(s), keypad, keyboard, trackpad, mouse, etc.

As further depicted in FIG. 1, computing device 100 has several data capture devices, such as sensing transducers, the physical stimulation of which produces signaling that may be sampled, digitized, and stored as captured data. Camera 110 includes an image sensor 112, along with additional hardware for digitizing, processing, and storing portions of the image sensor 112 output. Camera 110 also includes optics that may form a portion of housing 102. Camera 110 may record still images, motion video, or both.

Microphone 114 includes audio capture circuitry that samples, digitizes, and stores portions of the signaling produced by microphone 114 in response to sensed acoustic stimulus. Microphone 114 is typically activated together with camera 110 when data capture device 100 is operated to record videos.

Global positioning system (GPS) receiver 116 includes an antenna and radio receiver circuitry to receive multiple signals being broadcast by a constellation of Earth-orbiting satellites, along with processing circuitry to discern the current position on the Earth of data computing device 100. Accelerometer 118 includes a multi-axis sensor that produces signaling in response to changes in motion, and electronics to sample and digitize that signaling. Magnetometer 120 includes sensors and supporting circuitry that detect the direction and intensity of the ambient magnetic field, or any externally-applied magnetic fields. Biometric sensor 122 includes an array of sensors for measuring a biometric indicator, such as a user's fingerprint, along with supporting circuitry.

The various data capture devices, whether individually, or in combination with one or more other data capture devices, may obtain information from which computing device 100 may discern facts about its operational state(s) or surrounding environment. For example, accelerometer 118 and magnetometer 120 may be used in combination to determine the orientation of computing device 100 with greater accuracy than either of these data capture devices alone.

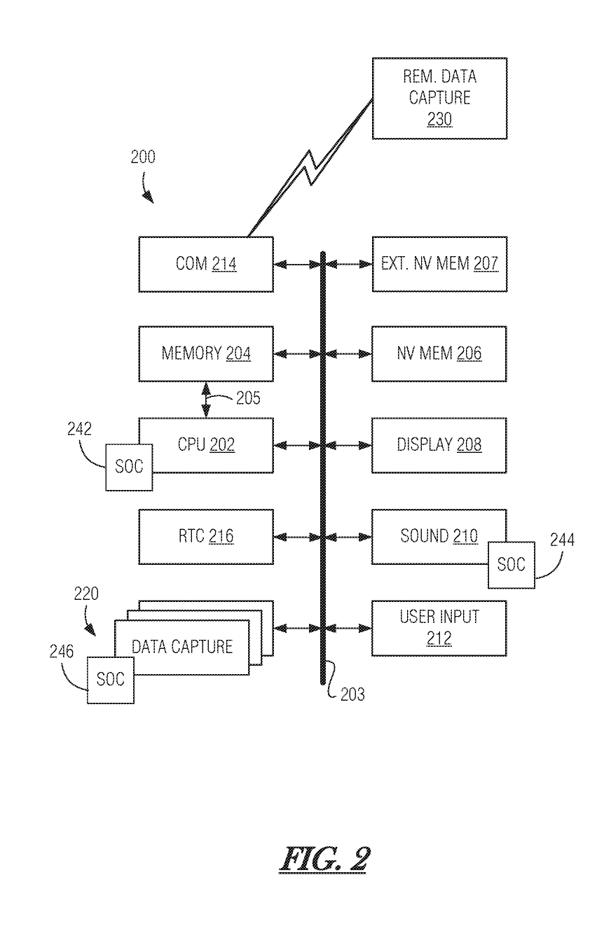

FIG. 2 is a block diagram illustrating an exemplary system architecture 200 of computing device 100 according to an embodiment. Central processor unit (CPU) 202 includes one or more microprocessors on which the overall functionality of computing device 100 is executed. CPU 202 is formed from hardware that is electrically interfaced with system link 203, which carries data and control signaling between the various components. As illustrated, system link 203 is similarly interfaced with each of the other components of system architecture 200. Memory 204 includes working memory space, and is constructed from suitable high-speed memory devices such as synchronous dynamic random access memory (SDRAM). In the embodiment illustrated, CPU 202 may access memory 204 using high-speed interface 205. Non-volatile memory 206 is constructed using read-only memory (ROM), electrically-erasable programmable read-only memory (EEPROM), flash memory or other suitable non-volatile storage technology. Non-volatile memory 206 stores system and application software that is executed by CPU 202 and, in some cases, by processors present in one or more other components.

External non-volatile memory 207 includes an interface such as a secure digital (SD) card slot, which may accept removable storage media to be used as additional non-volatile data storage.

Display 208 includes display 104 and circuitry for interfacing the display 104 with the system, as well as video driving circuitry. Sound 210 contains circuitry for driving the audio output to a speaker or headphones, and the circuitry for interfacing with the system. User input 212 contains the circuitry for interfacing with input devices such as input device 106. Communications block 214 represents communications circuitry and circuitry for interfacing the communications circuitry with the system. Communications block 214 may include a radio for communicating over a cellular network such as a network designed according to the Long-Term Evolution (LTE), LTE-Advanced, 5G or Global System for Mobile Communications (GSM) families of standards. Also, communications circuitry 214 may include a Wi-Fi communications radio according to the IEEE 801.11 family of standards, or a Bluetooth radio circuit according to the IEEE 802.15 family of standards. Real-time clock 216 includes circuitry that provides a clock that maintains the current date and time, and that interfaces the clock to the system.

Data capture devices 220 are integrated with computing device 200. According to various embodiments, data capture devices 220 include a plurality of different types of sensing transducers and their associated processing and interface circuitry, such as a camera, GPS, accelerometer, and biometric sensor.

In the case of a camera, the transducer may be an image sensor device, such as a charge-coupled device (CCD) array or a complementary metal-oxide semiconductor (CMOS)-based sensor. In the case of a GPS, the transducer is one or more GPS signal-receiving antennas. In the case of an accelerometer, the transducer may be a micro electro-mechanical system (MEMS)-based device utilizing capacitive, piezoelectric, or other suitable technology to produce electrical signaling. In the case of a biometric sensor, the transducer may be any suitable optical, capacitive, ultrasonic, chemical, or other sensor. It will be understood that these examples are provided herein for illustration and context, and are not meant to be limiting unless expressly enumerated in a particular claim.

The processing circuitry associated with each corresponding transducer may include amplification, buffering, filtering, or other signal-conditioning circuitry to receive the raw analog signal from the corresponding transducer and prepare the analog signaling for digitization, analog-to-digital conversion circuitry to perform sampling, quantization, and digital encoding, and, in some cases, further processing to produce a digital signal representing the physical phenomenon being measured by the transducer in a form that is readable by CPU 202.

Remote data capture device 230 is interfaced with CPU 202 via communication block 214, as depicted. Remote data capture device 230 may be any type of data capture device described above, or may be a different type of data capture device altogether.

In a related type of embodiment, system architecture 200 includes one or more systems on chips (SoCs) 242, 244, 246. One or more of the SoCs may be incorporated as part of CPU 202, sound 210, and one or more of data capture devices 220 as depicted. SoCs 242-246 may include analog, mixed-signal, and digital circuitry, including signal conditioning, A/D, D/A, memory and data-processing portions.

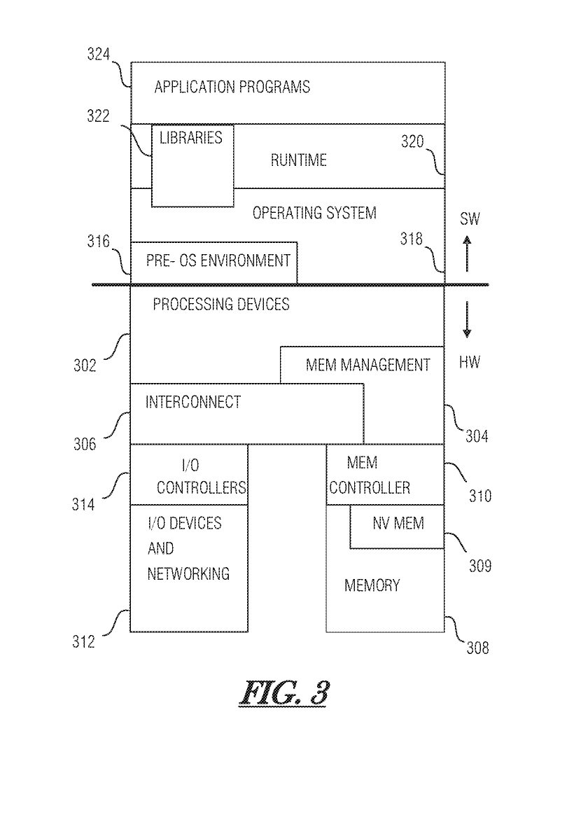

FIG. 3 is a diagram illustrating an exemplary hardware and software architecture of a computing platform on which various aspects of the embodiments may be realized. The computing platform may be transformed into a special-purpose machine by instructions that, when executed, cause the computing platform to carry out operations in accordance with one or more embodiments of the invention. In FIG. 3, various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores, are interfaced with memory management device 304 and system interconnect 306. Memory management device 304 provides mappings between virtual memory used by processes being executed, and the physical memory. Memory management device 304 may he an integral part of a central processing unit which also includes the processing devices 302,

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding 110 controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, described in greater detail below, is responsible for initiating the launching of the operating system, but also provides an execution environment for embedded applications according to certain aspects of the invention. Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) that facilitates interaction with the user via peripheral devices such as a monitor, keyboard, mouse, microphone, video camera, display, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

Examples, as described herein, may include, or may operate on, logic or a number of circuits, components, modules, or engines, which for the sake of consistency are termed engines, although it will be understood that these terms may be used interchangeably. Engines are tangible entities capable of performing specified operations and may be configured or arranged in a certain manner. Engines may be realized as hardware circuitry, as well one or more processors programmed via software or firmware (which may be stored in a data storage device interfaced with the one or more processors), in order to carry out the operations described herein. In this type of configuration, an engine includes both, the software, and the hardware (e.g., circuitry) components. In an example, circuits may be arranged (e.g., internally or with respect to external entities such as other circuits) in a specified manner as an engine. In an example, the whole or pail of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. With reference to FIG. 3, for instance, an engine may include one, or any combination, of the blocks depicted, so long as at least one block from the HW side is included.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time. In view of the above definition, engines are structural entities that have both, a physical structure, and an algorithmic structure. According to some embodiments, engines may constitute the structural means for performing certain algorithmic functions described herein.

A computing platform according to embodiments of the invention is a special-purpose machine that may be configured based on a general-purpose computing device, such as a personal computer (PC) having an architecture such as the one described in the example of FIG. 3. The computing platform may be one physical machine, or may be distributed among multiple physical machines, such as by role or function, or by process thread in the case of a cloud computing distributed model, in various embodiments, aspects of the embodiments may be configured to run in virtual machines that in turn are executed on one or more physical machines. It will be understood by persons of skill in the art that features of the invention may be realized by a variety of different suitable machine implementations.

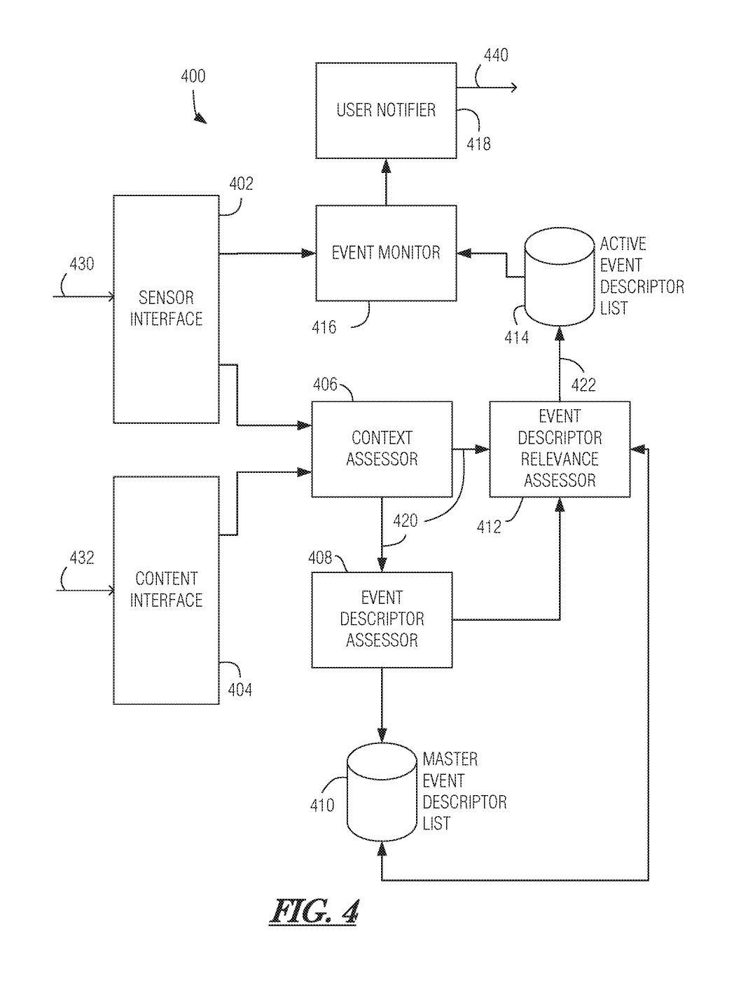

FIG. 4 is a system block diagram illustrating an environment-triggered user alert system 400 according to an example embodiment. In various embodiments, system 400 includes engines, which may be implemented using the hardware, or the hardware controlled by software or firmware, of a computing device such as described above with reference to FIGS. 1-3. For instance, various engines the entirety) of system 400 may be implemented using one or more of SoCs 242-246, in combination with components 202-230 (FIG. 2).

At its highest level, system 400 accepts input 430 from its surrounding environment, such as sounds, images, location information, and the like, and produces user notification 440 in response to input 430. Notification 440 may include an audible, visual, or haptic signal to the user, who at the moment may be otherwise distracted or isolated from his or her surrounding environment and unaware of the occurrence of the events that form the basis for input 430.

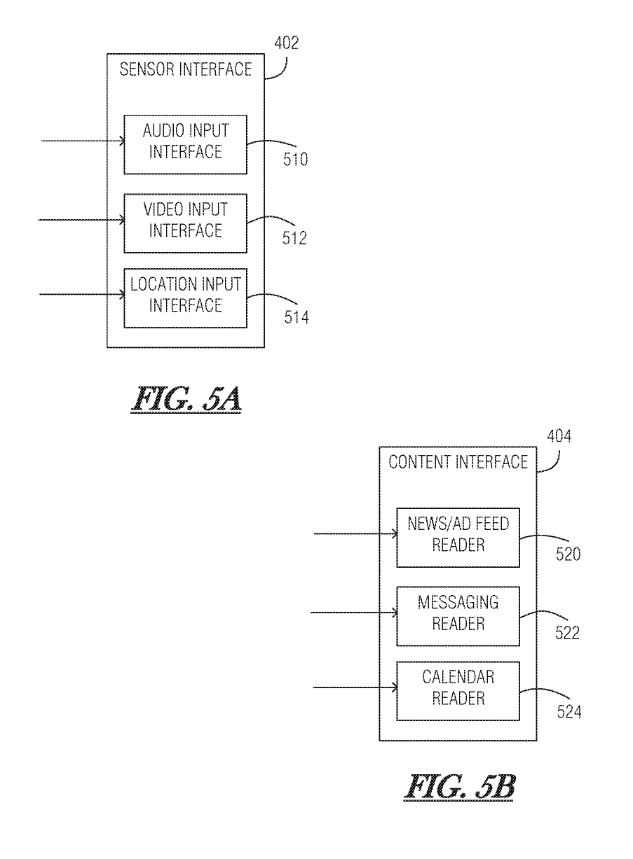

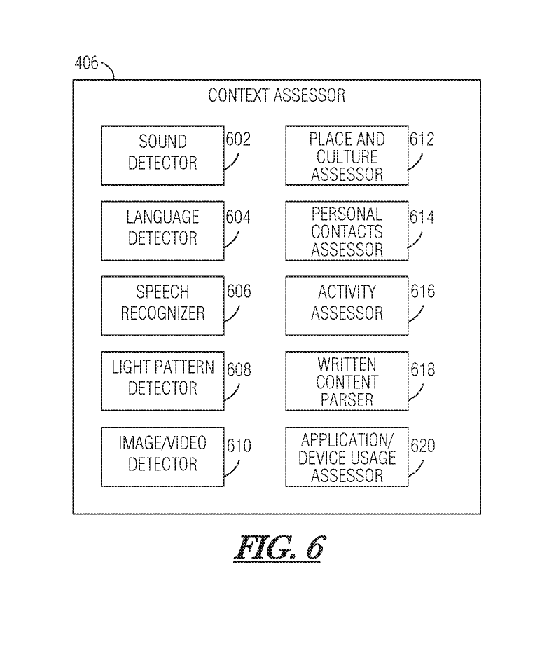

In addition, system 400 includes features that work to manage the quantity of monitored events while ensuring that the monitored events are relevant to the user based on the assessed context. Accordingly, system 400 includes two types of input interfaces: sensor interface 402, and content interface 404. FIGS. 5A and 5B respectively illustrate sensor interface 402 and content interface 404 in greater detail. Sensor interface 402 includes audio interface 510, such as input from a microphone, for example. Also, sensor interface 402 includes video input interface 512 (e.g., accepting the output from a camera), and location input interface 514 (e.g., accepting the output from a GPS device).

Content interface 404 includes news or advertisement feed reader 520 configured to read content from various subscription services, messaging reader 522, which is configured to read content from incoming email, short messaging system or multimedia messaging system (SMS/MMS) messages, social media updates, and the like, and calendar reader 524 configured to read the content of the user's calendar entries, contacts, travel itinerary, and other personal-relationship or user-activity-informative data.

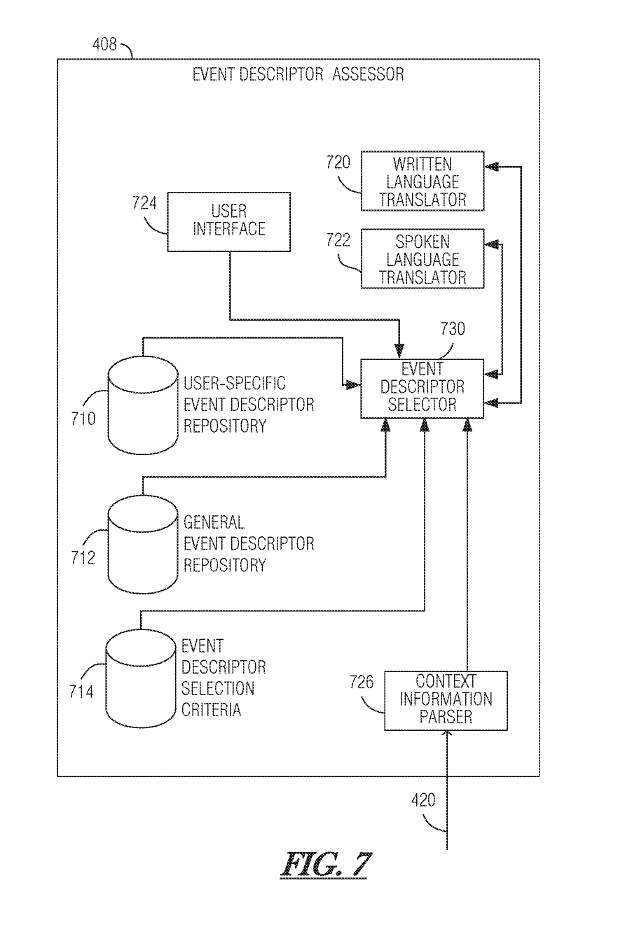

Returning to FIG. 4, sensor interface 402 and content interface 404 feed their respective Outputs into context assessor 406. Context assessor 406 is configured to interpret this incoming information to assess the present context in which the computing device is being used. FIG. 6 is a block diagram illustrating various components of context assessor 406 according to an example embodiment. These components may each use one, or a combination, of inputs to make various deductions or inferences regarding the present context.

As depicted, context assessor 406 includes sound detector 602 that is configured to recognize and distinguish between various sounds, such as human speech, chimes, sirens, alarms, machinery, and the like. Language detector 604 is configured to recognize the language in which spoken or written information is conveyed. Speech recognizer 606 is configured to convert speech to text light pattern detector 608 is configured to recognize changes in the lighting surrounding the computing device, including discerning whether the device is transported to or from a pocket, purse, or other container; whether the device is moved between an indoor or outdoor location, whether the lighting in the space where the device is located has been turned on or off, and the like. Image/video detector 610 is configured to detect objects, faces, or other information from captured still or motion video.

Place and culture assessor 612 is configured to determine at least one event characteristic particular to the country, city, or geographic region, where the computing device is being used. For example, place and culture assessor 612 may distinguish between various different characteristics of the signage, or sounds that may be used by police or other emergency services in different places. Similarly, spoken accents may be identified, and better accommodated, for purposes of improving speech recognition. Personal contacts assessor 614 is configured to draw connections between individuals named in incoming messaging or calendar entries, and the user's contact database, social media, or other information source, to assess the nature and extent of the personal relationships of those individuals and the user of the computing device. This information may be relevant to prioritizing the monitoring of certain types of monitored events.

Activity assessor 616 is configured to deduce or infer the user's current activity, such as travel, work, commuting, leisure, sport/exercise, gaming, sleep, attendance at certain venues, such as restaurants, theaters, stores, stadiums, etc. Written content parser 618 is configured to extract certain keywords or main ideas from monitored communications. Application device usage assessor 620 is configured to monitor the nature of the user's current work on, or interaction with, the computing device, such as listening to music, use of virtual- or augmented-reality system, watching video content, gaming, use of headphones, speaking via telephone or video conferencing system, etc.

Individually, or in various combinations, the components of context assessor 406 produce context indicia 420. In various embodiments, Context indicia 420 includes event descriptors extracted from received information as part of the context analysis, as well as computing device operational state, location, user activity, and other current context information.

Returning again to FIG. 4, context assessor 406 supplies output 420 to event descriptor assessor 408 and event descriptor relevance assessor 412. Event descriptor assessor 408 is configured to produce a set of event descriptors applicable to the context indicia 420. Event descriptors include such items as keywords (spoken or written), sounds, visual signs/symbols, etc. Event descriptor assessor 408 produces master event descriptor list 410, which includes event descriptors applicable to the assessed context.

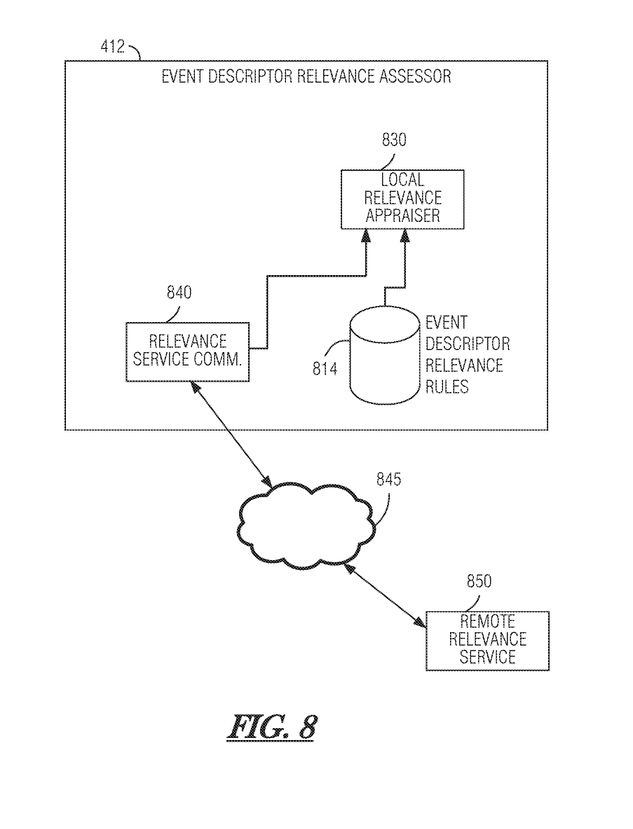

FIG. 7 is a block diagram illustrating event descriptor assessor 408 in greater detail according to an illustrative embodiment. User-specific event descriptor repository 710 includes event descriptors that are specifically entered by the user, and event descriptors that are obtained by analysis of the context indicia 420. For example, user-specific event descriptors may include such keywords as the user's name, “flight 755,” “123 Main Street,” etc. General event descriptor repository 712 includes event descriptors that are of general interest—such as the keywords “caution,” “attention,” “flight,” “curfew,” “sir,” “miss,” “hey,” “excuse me,” “approaching,” and the like.

Event descriptor selection criteria 714 are a set of logical relationships that define the applicability of event descriptors to various items represented in the assessed context. Written language translator 720 and spoken language translator 722 are configured to perform language translation of verbal event descriptors. User interface 724 facilitates user control of event descriptors, including such operations as adding or removing event descriptors, verifying relevance of event descriptors, editing the event descriptor selection criteria 714, and other related operations.

Context information parser 726 parses the context indicia 420 for any keywords, computing device operational state information, location information, language information, etc., and passes the parsed output to event descriptor selector 730. Event descriptor selector 730 is a decision engine that applies the event descriptor selection criteria 714 to parsed context indicia 420 to select event descriptors from among the user-specific event descriptor repository 710 and the general event descriptor repository 712, as well as any to be added to master event descriptor list 410. Event descriptor selector 730 may utilize either or both of the translators 720, 722, as appropriate, to produce verbal event descriptors in one or more additional languages.

Referring again to FIG. 4, event descriptor relevance assessor 412 is configured to determine relevance scoring for the event descriptors, and to maintain active event descriptor list 414 by adding, removing, or revising the event descriptors in the list 414 via active list update 422. In related embodiments, event descriptor relevance assessor 412 is also configured to communicate with a remote relevance service, which may provide relevance information for existing, and new, event descriptors.

FIG. 8 is a block diagram illustrating event descriptor relevance assessor 412 in greater detail according to an illustrative example embodiment. Event descriptor relevance assessor 412 includes event descriptor relevance rules 814 that define relevance-setting and updating criteria based on context and temporal proximity (e.g., freshness).

In an embodiment, event descriptor relevance rules 814 specify a preference (e.g., increased relevance scoring) to be given to user-specific event descriptors over generic event descriptors that are user-agnostic. In another embodiment, event descriptor relevance rules 814 specify a preference to be given to safety- or security-related keywords, sounds, or images. In another related embodiment, event descriptor relevance rules 814 specify a preference to be given to event descriptors that are specific to a current user activity determined by context assessor 406. In another related embodiment, event descriptor relevance rules 814 specify a preference to be given to event descriptors that statistically produce greater quantity of user-alerts, as determined based on feedback from a plurality of distinct user devices. In another related embodiment, event descriptor relevance rules 814 specify a preference to be given to event descriptors that were selected for active use by one or more other users designated as lead users.

Local relevance appraiser 830 is a decision engine that applies event descriptor relevance rules 814 to event descriptors based on the information in context assessment 420. Relevance rules 814 emphasize context information that is particular to the user, such as particular destinations, planned activities based on calendar entries, personal contacts, personal interests based on news feeds, and the like. In a related embodiment, local relevance appraiser 830 is further configured to prioritize the event descriptors based on the assessed relevance scoring, and to save the most relevant event descriptors in active event descriptor list 414 (FIG. 4).

In an embodiment, the most relevant event descriptors are the top N event descriptors, where N is a defined upper limit for actively-monitored event descriptors. In a related embodiment, N may be varied based on certain context or computing device operational indicia, such as signal strength, battery⁻ life remaining, current activity, current location, or the like. In a related embodiment, the most relevant event descriptors are those that have a relevance score exceeding a defined relevance threshold T. T may also be variable from time to time according to context.

In a related embodiment, event descriptor relevance assessor 412 may also include relevance service communications engine 840, which is configured to establish and conduct communications with remote relevance service 850 via communication network 845. Remote relevance service 850 may be a centralized service that communicates with a plurality of computing devices belonging to, or in the possession of, different users. Accordingly, remote relevance service 850 may assign event descriptors, and associated relevance scoring, based on crowd intelligence obtained by remote relevance service as feedback from the plurality of computing devices. An example of such feedback is locally-assessed event descriptors by each respective computing device having general relevance (e.g., not personally-identifying or specific to an individual), having a relatively high relevance score compared with other event descriptors.

In a related embodiment, the crowd-sourced feedback applicable to a given user's computing device is limited to crowd-member devices in a defined geographic proximity to the given user's device's location. In another related embodiment, remote relevance service 850 may preferentially use information obtained from lead users, such as individuals having a leadership role in a business organization in which a subject user is an employee, or other users having been previously at the location or activity context to which a given user's computing device has recently arrived.

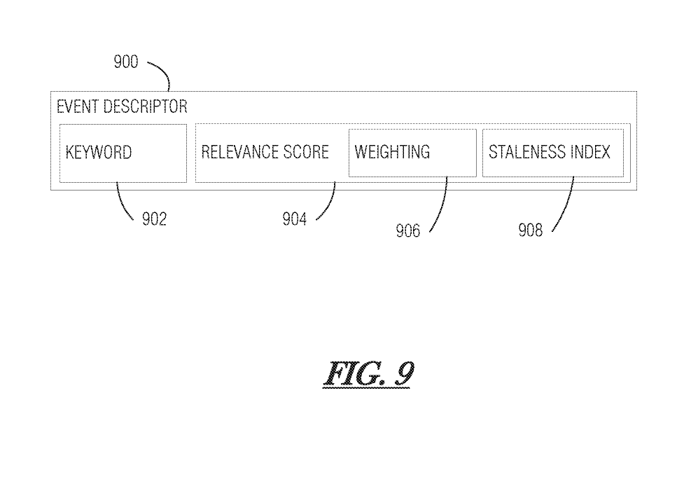

FIG. 9 is a diagram illustrating an illustrative example of a data structure 900 of an event descriptor. In this example, the event descriptor includes a keyword 902, and a relevance score 904. Relevance score 904 may include a weighting measure 906, which indicates the assessed subject-matter relevance of keyword 902 based on the current context. Staleness index 908 is a measure that represents a temporal relevance of keyword 902 to the present context. In general, staleness index 908 may be adjusted to indicate a reduced temporal relevance as a function of time. Different event descriptors such as keywords may have different staleness update characteristics. For instance, the keywords “storm,” “flood,” “hurricane,” “tornado,” “tsunami,” and the like, refer to passing events. As the usage of these terms for the vicinity diminishes, the staleness index may be increased, thereby decreasing the overall relevance score for these keywords.

Referring again to FIG. 4, the events represented in active event descriptor list 414 are monitored by event monitor 416. In response to an occurrence of a monitored event, user notifier 418 generates notification 440, which may be dynamically selected based on the current usage of the computing device. For example, if the device is being used for music playback without its display being active, an audible notification may be issued. Similarly, if the device is being used with a virtual-reality headset, a visual notification may be issued.

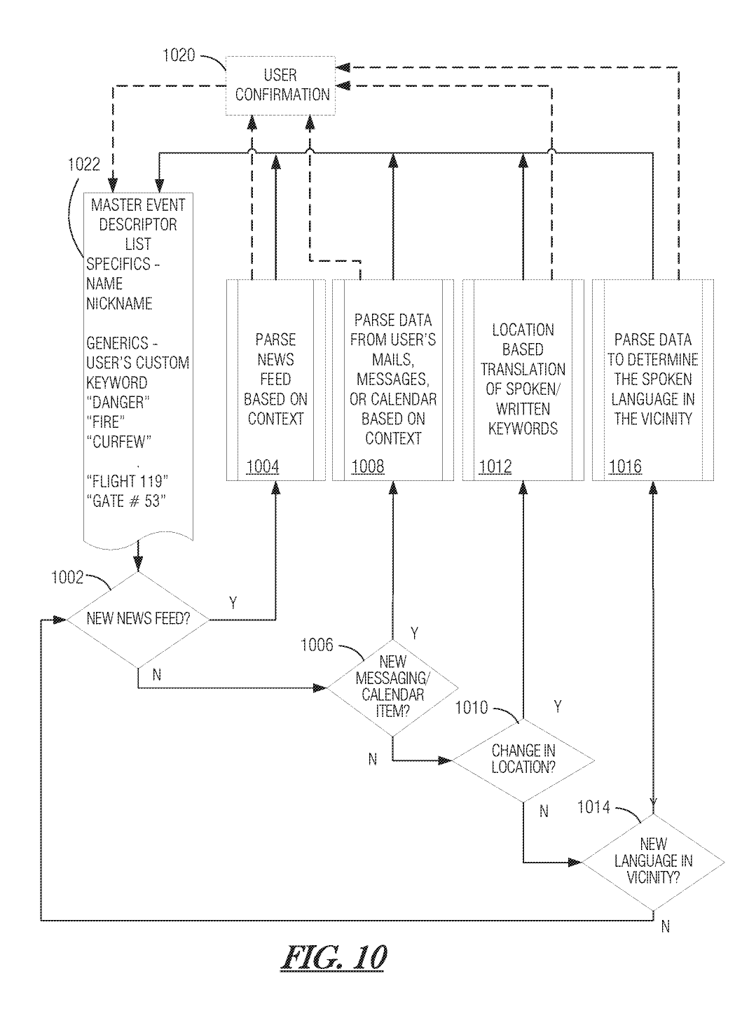

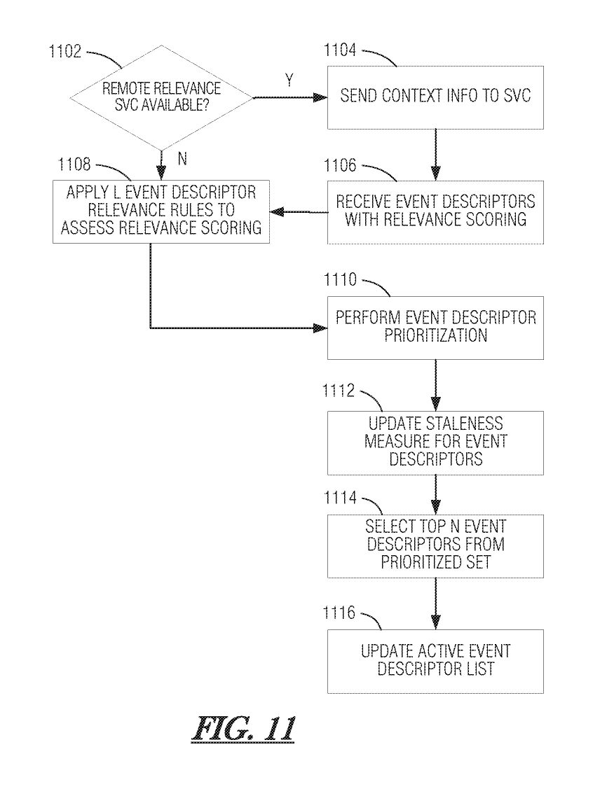

FIGS. 10 and 11 are flow diagrams illustrating an example of the operation of system 400 in creating or maintaining master event descriptor list 410, and creating and maintaining active event descriptor list 414 according to various embodiments. It is important to note that the example processes are richly-featured embodiments that may be realized as described; in addition, portions of the processes may be implemented while others are excluded in various embodiments. The following Additional Notes and Examples section details various combinations, without limitation, that are contemplated. It should also be noted that in various embodiments, certain process operations may be performed in a different ordering than depicted, provided that the logical flow and integrity of the process is not disrupted in substance.

FIG. 10 illustrates operations for managing master event descriptor list 410 according to an example embodiment. In general, at operations 1002-1016 event descriptor assessor 408 parses various sources of event descriptors, such as keywords, based on their contextual relevance, to propose candidates for the active keyword. Some of the ways of updating the master event descriptor list according to various embodiments are depicted as follows:

At 1002, context information parser 726 checks if a new news teed has arrived, and at 1004, parses the news feed based on the reported context 420. In the affirmative case the newsfeed is parsed by context assessor 406, content information parser 726, or both, for relevant keywords for addition of the keyword(s) to the master event descriptor list 410. For example, if the user has a flight booked to a country and there is a news article on the ongoing violence in that country, then the appropriate keywords pertaining to the country, pertaining to locations within that country, and pertaining to personal safety and security, including translations of those keywords into the native or official language of that country, are added to the master event descriptor list 410 by event descriptor assessor 408.

At 1006, context information parser 726 checks if a new messaging or calendar item has arrived or been created. Messaging includes email, text or multimedia messaging, social-media messaging, and the like. In the affirmative case the messaging or calendar entry is parsed by context assessor 406, content information parser 726, or both, for relevant keywords to become aware of the user's travel plans, appointments etc., and thus look for the appropriate key words, which may be found in user-specific event descriptor repository 710, general event description repository 712, or in the messaging/calendar entry item(s). For example, when the user is travelling and is at the airport, the flight number, the designated gate number, the ticket ID, and other relevant user-specific items of information may be selected as keywords.

At 1010, context information parser 72.6 checks if a change in location has occurred to a place where a different language is used. In the affirmative case, at 1012, event descriptor assessor 408 uses written language translator 720 or spoken language translator 722 to translate keywords or audible words or phrases into the language used at the new location. The keywords subject to translation may be those in the master event descriptor list 410, or it may be limited to only those keywords in the active event descriptor list 414.

At 1014, context information parser 72.6 checks the captured ambient soundscape in the vicinity of the computing device for speech, and analyzes that speech to check if an unrecognized language (e.g., other than the one in which keywords are currently being monitored), is being spoken. In various embodiments, the language analysis may be performed locally by system 400, or remotely, by remote relevance service 850, for instance. In the latter case, samples of the local soundscape may be sent to remote relevance service 850 for analysis. When in a mall, the application could parse the unicasted/broadcasted advertisements to the user and pick up keywords of interest. In the affirmative case, at 1016, the new language is parsed and analyzed to determine the language, and keywords being used as part of the event descriptors (e.g., in active event descriptor list 414) are translated into the detected language.

As depicted in this example embodiment, in the negative case for each of the decisions, the process may advance to the next decision block, and cycles back to check for any subsequent changes or applicable event detections. In a related embodiment, in response to each keyword update, user confirmation may be sought at 1020 before updating the master event descriptor list 414. At 1022, the master event descriptor list 410 is updated with new keywords, translated keywords or audible sounds, etc.

FIG. 11 illustrates operations for managing active event descriptor list 414 according to an example embodiment. This embodiment has both, local relevance appraiser 830, and access to remote relevance service 850. At 1102, event descriptor relevance assessor 412, using relevance service communicator 840, checks if remote relevance service 850 is available. In the affirmative case, at 1104, relevance service communicator 840 sends the context assessment information 420 to remote relevance service 850. At 1106, relevance service communicator 840 receives event descriptors with corresponding relevance scoring from remote relevance service 850.

Accordingly, the event descriptors added to the master list 410 may be pushed to remote relevance service 850, where a relevance score is attached to each event descriptor. In such a system, the specific keywords would be the user's name and nickname and the mandatory generics are the keywords that the user has added. Supposing the total number of keywords has to be restricted to five, the relevance engine loads the new generic keywords (obtained by the user's context) to the cloud, the cloud responds with a weightage for the keywords. The weightage could be based on the feedback from other users on the keywords used in a location or a particular context like being at a mall or an airport. The staleness of the keyword will also be a factor for the weightage of the keyword to be considered.

The process proceeds to block 1108, where local relevance appraiser 830 applies the event descriptor relevance rules 814 to assess the relevance scoring for the event descriptors in the master list 410. In the case where remote relevance service 850 is available, operation 1108 may be coordinated with the remote relevance service 850 such that certain functionality of remote relevance service 850 supersedes similar functionality of local relevance appraiser 830.

The process advances 1110, where local relevance appraiser 830 performs event descriptor prioritization. In an example, prioritization involves ordering the event descriptors by relevance score. At 1112, the staleness measure for the event descriptors is updated. This operation may be performed by local relevance appraiser 830, remote relevance service 850, or by a combination of these engines. At 1114, selection criteria is applied by local relevance appraiser 830 to select a subset of the event descriptors to be used for monitoring. These may be the top N descriptors, or all of the event descriptors exceeding a relevance score threshold, as described above, for instance.

At 1116, the active event descriptor list 414 is updated by event descriptor relevance assessor 412.

### ADDITIONAL NOTES & EXAMPLES

Example 1 is a system for notifying a user of a computing device in response to detectable events, the system comprising: a context assessor to generate context indicia relating to usage of the computing device based on sensor data and content data of the computing device; an event descriptor assessor to produce a master set of event descriptors based on the context indicia and on event descriptor selection criteria, the event descriptors representing events monitorable by the computing device; and an event descriptor relevance assessor to produce an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered.

In Example 2, the subject matter of Example 1 optionally includes wherein the event descriptors include keywords.

In Example 3, the subject matter of any one or more of Examples 1-2 optionally include wherein the event descriptors include audible sounds.

In Example 4, the subject matter of any one or more of Examples 1-3 optionally include wherein the event descriptors include audible speech.

In Example 5, the subject matter of any one or more of Examples 1-4 optionally include wherein the sensor data includes captured data selected from the group consisting of audio data, video data, location data, or any combination thereof.

In Example 6, the subject matter of any one or more of Examples 1-5 optionally include wherein the content data includes messaging content.

In Example 7, the subject matter of any one or more of Examples 1-6 optionally include wherein the content data includes information feed content.

In Example 8, the subject matter of any one or more of Examples 1-7 optionally include wherein the content data includes user calendar content.

In Example 9, the subject matter of any one or more of Examples 1-8 optionally include wherein the context assessor is to determine a current activity and location of a user of the computing device.

In Example 10, the subject matter of any one or more of Examples 1-9 optionally include wherein the context assessor is to detect a language being spoken in a vicinity of the user.

In Example 11, the subject matter of any one or more of Examples 1-10 optionally include wherein the relevance scoring includes a measure of relevance weighting and a separate measure of staleness.

In Example 12, the subject matter of any one or more of Examples 1-11 optionally include wherein the event descriptor assessor includes at least one repository of event descriptors, and wherein certain event descriptors from the at least one repository are selected to be included in the master set in response to the context indicia.

In Example 13, the subject matter of Example 12 optionally includes wherein the at least one repository of event descriptors includes a first repository of general event descriptors, and a second repository of user-specific event descriptors.

In Example 14, the subject matter of any one or more of Examples 1-13 optionally include wherein the event descriptor assessor includes a language translator to translate at least one of: written language or spoken language, based on the context indicia indicating usage of the computing device in a new place associated with a different language to a language previously in use at a prior place.

In Example 15, the subject matter of any one or more of Examples 1-14 optionally include wherein the event descriptor relevance assessor includes event descriptor relevance criteria that specifies a relevance scoring preference to be given to user-specific event descriptors over generic event descriptors that are user-agnostic.

In Example 16, the subject matter of any one or more of Examples 1-15 optionally include wherein the event descriptor relevance assessor includes event descriptor relevance criteria that specifies a relevance scoring preference to be given to safety- or security-related event descriptors.

In Example 17, the subject matter of any one or more of Examples 1-16 optionally include wherein the event descriptor relevance assessor includes event descriptor relevance criteria that specifies a quantity limit on event descriptors to be included in the active subset.

In Example 18, the subject matter of any one or more of Examples 1-17 optionally include wherein the event descriptor relevance assessor includes a relevance service communications engine that interfaces with a centralized remote relevance service that supports a plurality of distinct computing devices.

In Example 19, the subject matter of any one or more of Examples 1-18 optionally include wherein the context assessor, the event descriptor assessor, and the event descriptor relevance assessor, are each an engine of the computing device.

In Example 20, the subject matter of Example 19 optionally includes wherein the context assessor, the event descriptor assessor, and the event descriptor relevance assessor, are each implemented at least in part on a system-on-chip device.

In Example 21, the subject matter of any one or more of Examples 19-20 optionally include wherein the context assessor, the event descriptor assessor, and the event descriptor relevance assessor, are each implemented at least in part on a processor-based computing platform of the computing device.

Example 22 is a method for notifying a user of a computing device in response to detectable events, the method comprising: generating, by the computing device, context indicia relating to usage of the computing device based on sensor data and content data of the computing device; producing, by the computing device, a master set of event descriptors based on the context indicia and on event descriptor selection criteria, the event descriptors representing events monitorable by the computing device; producing, by the computing device, an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered; monitoring, by the computing device, an environment of the computing device for any occurrence of events represented by the event descriptors of the active subset; and generating, by the computing device, a user notification in response to the detected occurrence of the event represented by an event descriptor of the active subset.

In Example 23, the subject matter of Example 22 optionally includes wherein the event descriptors include keywords.

In Example 24, the subject matter of any one or more of Examples 22-23 optionally include wherein the event descriptors include audible sounds.

In Example 25, the subject matter of any one or more of Examples 22-24 optionally include wherein the event descriptors include audible speech.

In Example 26, the subject matter of any one or more of Examples 22-25 optionally include wherein the sensor data includes captured data selected from the group consisting of: audio data, video data, location data, or any combination thereof.

In Example 27, the subject matter of any one or more of Examples 22-26 optionally include wherein the content data includes messaging content.

In Example 28, the subject matter of any one or more of Examples 22-27 optionally include wherein the content data includes information feed content.

In Example 29, the subject matter of any one or more of Examples 22-28 optionally include wherein the content data includes user calendar content.

In Example 30, the subject matter of any one or more of Examples 22-29 optionally include wherein generating the context indicia includes determining a current activity and location of a user of the computing device.

In Example 31, the subject matter of any one or more of Examples 22-30 optionally include wherein generating the context indicia includes detecting a language being spoken in a vicinity of the user.

In Example 32, the subject matter of any one or more of Examples 22-31 optionally include wherein the relevance scoring includes a measure of relevance weighting and a separate measure of staleness.

In Example 33, the subject matter of any one or more of Examples 22-32 optionally include wherein producing the master set of event descriptors includes selecting certain event descriptors from at least one repository of event descriptors, for inclusion in the master set in response to the context indicia.

In Example 34, the subject matter of Example 33 optionally includes wherein the at least one repository of event descriptors includes a first repository of general event descriptors, and a second repository of user-specific event descriptors.

In Example 35, the subject matter of any one or more of Examples 22-34 optionally include wherein producing the master set of event descriptors includes translating at least one of written language or spoken language, based on the context indicia indicating usage of the computing device in a new place associated with a different language to a language previously in use at a prior place.

In Example 36, the subject matter of any one or more of Examples 22-35 optionally include wherein producing the master set of event descriptors includes applying event descriptor relevance criteria that specifies a relevance scoring preference to be given to user-specific event descriptors over generic event descriptors that are user-agnostic.

In Example 37, the subject matter of any one or more of Examples 22-36 optionally include wherein producing the master set of event descriptors includes applying event descriptor relevance criteria that specifies a relevance scoring preference to be given to safety- or security-related event descriptors.

In Example 38, the subject matter of any one or more of Examples 22-37 optionally include wherein producing the active subset of event descriptors includes applying event descriptor relevance criteria that specifies a quantity limit on event descriptors to be included in the active subset.

In Example 39, the subject matter of any one or more of Examples 22-38 optionally include wherein producing an active subset of event descriptors includes interfacing with a centralized remote relevance service that supports a plurality of distinct computing devices.

Example 40 is at least one machine-readable medium comprising instructions that, when executed on a processor-based computing device, cause the computing device to perform the method according to any one of Examples 22-39.

Example 41 is a system for notifying a user of a computing device in response to detectable events, the system comprising means for performing the method according to any one of Examples 22-39.

Example 42 is at least one machine-readable medium comprising instructions that, when executed on a processor-based computing platform of a computing device, cause the computing device to: generate context indicia relating to usage of the computing device based on sensor data and content data of the computing device; produce a master set of event descriptors based on the context indicia and on event descriptor selection criteria, the event descriptors representing events monitorable by the computing device: produce an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered; monitor an environment of the computing device for any occurrence of events represented by the event descriptors of the active subset; and generate a user notification in response to the detected occurrence of the event represented by an event descriptor of the active subset.

In Example 43, the subject matter of Example 42 optionally includes wherein the event descriptors include keywords.

In Example 44, the subject matter of any one or more of Examples 42-43 optionally include wherein the event descriptors include audible sounds.

In Example 45, the subject matter of any one or more of Examples 42-44 optionally include wherein the event descriptors include audible speech.

In Example 46, the subject matter of any one or more of Examples 42-45 optionally include wherein the sensor data includes captured data selected from the group consisting of: audio data, video data, location data, or any combination thereof.

In Example 47, the subject matter of any one or more of Examples 42-46 optionally include wherein the content data includes messaging content.

In Example 48, the subject matter of any one or more of Examples 42-47 optionally include wherein the content data includes information feed content.

In Example 49, the subject matter of any one or more of Examples 42-48 optionally include wherein the content data includes user calendar content.

In Example 50, the subject matter of any one or more of Examples 42-49 optionally include wherein the instructions for causing the computing device to generate the context indicia include instructions for determining a current activity and location of a user of the computing device.

In Example 51, the subject matter of any one or more of Examples 42-50 optionally include wherein the instructions for causing the computing device to generate the context indicia include instructions for detecting a language being spoken in a vicinity of the user.

In Example 52, the subject matter of any one or more of Examples 42-51 optionally include wherein the relevance scoring includes a measure of relevance weighting and a separate measure of staleness.

In Example 53, the subject matter of any one or more of Examples 42-52 optionally include wherein the instructions for causing the computing device to produce the master set of event descriptors include instructions for selecting certain event descriptors from at least one repository of event descriptors, for inclusion in the master set in response to the context indicia.

In Example 54, the subject matter of Example 53 optionally includes wherein the at least one repository of event descriptors includes a first repository of general event descriptors, and a second repository of user-specific event descriptors,

In Example 55, the subject matter of any one or more of Examples 42-54 optionally include wherein the instructions for causing the computing device to produce the master set of event descriptors include instructions for translating at least one of: written language or spoken language, based on the context indicia indicating usage of the computing device in a new place associated with a different language to a language previously in use at a prior place.

In Example 56, the subject matter of any one or more of Examples 42-55 optionally include wherein the instructions for causing the computing device to produce the master set of event descriptors include instructions for applying event descriptor relevance criteria that specifies a relevance scoring preference to be given to user-specific event descriptors over generic event descriptors that are user-agnostic.

In Example 57, the subject matter of any one or more of Examples 42-56 optionally include wherein the instructions for causing the computing device to produce the master set of event descriptors include instructions for applying event descriptor relevance criteria that specifies a relevance scoring preference to be given to safety- or security-related event descriptors.

In Example 58, the subject matter of any one or more of Examples 42-57 optionally include wherein the instructions for causing the computing device to produce the active subset of event descriptors include instructions for applying event descriptor relevance criteria that specifies a quantity limit on event descriptors to be included in the active subset.

In Example 59, the subject matter of any one or more of Examples 42-58 optionally include wherein the instructions for causing the computing device to produce an active subset of event descriptors include instructions for interfacing with a centralized remote relevance service that supports a plurality of distinct computing devices.

Example 60 is a system for notifying a user of a computing device in response to detectable events, the system comprising: means for generating context indicia relating to usage of the computing device based on sensor data and content data of the computing device; means for producing a master set of event descriptors based on the context indicia and on event descriptor selection criteria, the event descriptors representing events monitorable by the computing device; and means for producing an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered.

In Example 61, the subject matter of Example 60 optionally includes means for monitoring an environment of the computing device for any occurrence of events represented by the event descriptors of the active subset; and means for generating a user notification in response to the detected occurrence of the event represented by an event descriptor of the active subset.

In Example 62, the subject matter of any one or more of Examples 60-61 optionally include wherein the event descriptors include keywords.

In Example 63, the subject matter of any one or more of Examples 60-62 optionally include wherein the event descriptors include audible sounds.

In Example 64, the subject matter of any one or more of Examples 60-63 optionally include wherein the event descriptors include audible speech.

In Example 65, the subject matter of any one or more of Examples 60-64 optionally include wherein the sensor data includes captured data selected from the group consisting of: audio data, video data, location data, or any combination thereof.

In Example 66, the subject matter of any one or more of Examples 60-65 optionally include wherein the content data includes messaging content.

In Example 67, the subject matter of any one or more of Examples 60-66 optionally include wherein the content data includes information feed content.

In Example 68, the subject matter of any one or more of Examples 60-67 optionally include wherein the content data includes user calendar content.

In Example 69, the subject matter of any one or more of Examples 60-68 optionally include wherein the means for generating the context indicia include means for determining a current activity and location of a user of the computing device.

In Example 70, the subject matter of any one or more of Examples 60-69 optionally include wherein the means for generating the context indicia include means for detecting a language being spoken in a vicinity of the user.

In Example 71, the subject matter of any one or more of Examples 60-70 optionally include wherein the relevance scoring includes a measure of relevance weighting and a separate measure of staleness.

In Example 72, the subject matter of any one or more of Examples 60-71 optionally include wherein the means for producing the master set of event descriptors include means for selecting certain event descriptors from at least one repository of event descriptors, for inclusion in the master set in response to the context indicia.

In Example 73, the subject matter of Example 72 optionally includes wherein the at least one repository of event descriptors includes a first repository of general event descriptors, and a second repository of user-specific event descriptors.

In Example 74, the subject matter of any one or more of Examples 60-73 optionally include wherein the means for producing the master set of event descriptors include means for translating at least one of: written language or spoken language, based on the context indicia indicating usage of the computing device in a new place associated with a different language to a language previously in use at a prior place.

In Example 75, the subject matter of any one or more of Examples 60-74 optionally include wherein the means for producing the master set of event descriptors include means for applying event descriptor relevance criteria that specifies a relevance scoring preference to be given to user-specific event descriptors over generic event descriptors that are user-agnostic.

In Example 76, the subject matter of any one or more of Examples 60-75 optionally include wherein the means for producing the master set of event descriptors include means for applying event descriptor relevance criteria that specifies a relevance scoring preference to be given to safety- or security-related event descriptors.

In Example 77, the subject matter of any one or more of Examples 60-76 optionally include wherein the means for producing the active subset of event descriptors include means for applying event descriptor relevance criteria that specifies a quantity limit on event descriptors to be included in the active subset.

In Example 78, the subject matter of any one or more of Examples 60-77 optionally include wherein the means for producing an active subset of event descriptors include means for interfacing with a centralized remote relevance service that supports a plurality of distinct computing devices.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” but not A,” and “A and B,” unless otherwise indicated. In the appended claims, the terms “including” and “in which” are used as the plain-English equivalents of the respective terms “comprising” and “wherein,” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for notifying a user of a computing device in response to detectable events, the system comprising:
computing hardware including at least one processor and at least one data store operatively coupled to the at least one processor, the computing hardware being configured to implement:
a context assessor to generate context indicia relating to usage of the computing device based on sensor data and content data of the computing device;
an event descriptor assessor to produce a master set of event descriptors based on the context indicia and on event descriptor selection criteria, the event descriptors representing events monitorable by the computing device;
an event descriptor relevance assessor to produce an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device
an event monitor to monitor an environment of the computing device for any occurrence of events represented by the event descriptors of the active subset and
a notifier to generate a user notification in response to detection of any of the events monitored by the event monitor.

2. The system of claim 1, wherein the event descriptors include keywords.

3. The system of claim 1, wherein the event descriptors include audible sounds.

4. The system of claim 1, wherein the event descriptors include audible speech.

5. The system of claim 1, wherein the context assessor is to detect a language being spoken in a vicinity of the user.

6. The system of claim 1, wherein the relevance scoring includes a measure of relevance weighting and a separate measure of staleness.

7. The system of claim 1, wherein the event descriptor assessor includes at least one repository of event descriptors, and wherein certain event descriptors from the at least one repository are selected to be included in the master set in response to the context indicia.

8. The system of claim 1, wherein the event descriptor assessor includes a language translator to translate at least one of:
written language or spoken language, based on the context indicia indicating usage of the computing device in a new place associated with a different language to a language previously in use at a prior place.

9. The system of claim 1, wherein the event descriptor relevance assessor includes event descriptor relevance criteria that specifies a relevance scoring preference to be given to user-specific event descriptors over generic event descriptors that are user-agnostic.

10. The system of claim 1, wherein the event descriptor relevance assessor includes event descriptor relevance criteria that specifies a relevance scoring preference to be given to safety- or security-related event descriptors.

11. The system of claim 1, wherein the event descriptor relevance assessor includes event descriptor relevance criteria that specifies a quantity limit on event descriptors to be included in the active subset.

12. The system of claim 1, wherein the event descriptor relevance assessor includes a relevance service communications engine that interfaces with a centralized remote relevance service that supports a plurality of distinct computing devices.

13. The system of claim 1, wherein the event monitor, notifier, context assessor, the event descriptor assessor, and the event descriptor relevance assessor, are each an engine of the computing device.

14. At least one non-transitory machine-readable medium comprising instructions that, when executed on a processor-based computing platform of a computing device, cause the computing device to:
generate context indicia relating to usage of the computing device based on sensor data and content data of the computing device;
produce a master set of event descriptors based on the context indicia and on event descriptor selection criteria, the event descriptors representing events monitorable by the computing device;
produce an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered;
monitor an environment of the computing device for any occurrence of events represented by the event descriptors of the active subset; and
generate a user notification in response to the detected occurrence of the event represented by an event descriptor of the active subset.

15. The at least one machine-readable medium of claim 14, wherein the relevance scoring includes a measure of relevance weighting and a separate measure of staleness.

16. The at least one machine-readable medium of claim 14, wherein the instructions for causing the computing device to produce the master set of event descriptors include instructions for selecting certain event descriptors from at least one repository of event descriptors, for inclusion in the master set in response to the context indicia.

17. The at least one machine-readable medium of claim 14, wherein the instructions for causing the computing device to produce the master set of event descriptors include instructions for translating at least one of:
written language or spoken language, based on the context indicia indicating usage of the computing device in a new place associated with a different language to a language previously in use at a prior place.

18. The at least one machine-readable medium of claim 14, wherein the instructions for causing the computing device to produce the master set of event descriptors include instructions for applying event descriptor relevance criteria that specifies a relevance scoring preference to be given to user-specific event descriptors over generic event descriptors that are user-agnostic.

19. The at least one machine-readable medium of claim 14, wherein the instructions for causing the computing device to produce the master set of event descriptors include instructions for applying event descriptor relevance criteria that specifies a relevance scoring preference to be given to safety- or security-related event descriptors.

20. The at least one machine-readable medium of claim 14, wherein the instructions for causing the computing device to produce the active subset of event descriptors include instructions for applying event descriptor relevance criteria that specifies a quantity limit on event descriptors to be included in the active subset.

21. The at least one machine-readable medium of claim 14, wherein the instructions for causing the computing device to produce an active subset of event descriptors include instructions for interfacing with a centralized remote relevance service that supports a plurality of distinct computing devices.

22. A method for notifying a user of a computing device in response to detectable events, the method comprising:
generating, by the computing device, context indicia relating to usage of the computing device based on sensor data and content data of the computing device;
producing, by the computing device, a master set of event descriptors based on the context indicia and on event descriptor selection criteria, the event descriptors representing events monitorable by the computing device;
producing, by the computing device, an active subset of event descriptors based on the context indicia and on relevance scoring corresponding to the event descriptors of the master set, wherein the active set includes event descriptors from the master set determined to have relatively higher relevance to the usage of the computing device and omits event descriptors from the master set determined to have relatively lower relevance to the usage of the computing device, wherein the active subset represents events to be monitored by the computing device, wherein in response to detection of any of the events to be monitored a user notification is triggered;
monitoring, by the computing device, an environment of the computing device for any occurrence of events represented by the event descriptors of the active subset; and
generating, by the computing device, a user notification in response to the detected occurrence of the event represented by an event descriptor of the active subset.

23. The method of claim 22, wherein the sensor data includes captured data selected from the group consisting of: audio data, video data, location data, or any combination thereof

24. The method of claim 22, wherein producing the active subset of event descriptors includes applying event descriptor relevance criteria that specifies a quantity limit on event descriptors to be included in the active subset.

25. The method of claim 22, wherein producing an active subset of event descriptors includes interfacing with a centralized remote relevance service that supports a plurality of distinct computing devices.
